(19) United States
(12) Patent Application Publication
(10) Pub. No.: US 2018/0334550 A1
(43) Pub. Date: Nov. 22, 2018

(54) Stabilized Polyolefin-Polymer Compositions and Related Methods

(71) Applicant: Dover Chemical Corporation, Dover, OH (US)

(72) Inventors: Mick JAKUPCA, Canton, OH (US); Jacob LANCE, New Philadelphia, OH (US); Don STEVENSON, Dover, OH (US); Jacob Weingart, Canton, OH (US)

(21) Appl. No.: 15/722,659

(22) Filed: Oct. 2, 2017

Related U.S. Application Data
(60) Provisional application No. 62/508,770, filed on May 19, 2017.

(51) Int. Cl. C08K 5/524; C08J 5/18; C08K 5/105; C08K 5/17

(52) U.S. Cl. CPC C08K 5/524; C08J 5/18; B29C 47/0057; C08K 5/17; C08J 2323/06; C08K 5/105

(57) ABSTRACT

A composition having a film having linear low density polyethylene and a first antioxidant component that is:

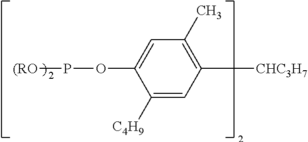

wherein each R moiety is independently selected and is a C8-C20 alkyl moiety.

### CROSS-REFERENCE TO RELATED APPLICATIONS

This patent application claims priority to U.S. provisional patent application titled, “Stabilized Polyethylene Compositions for Films, With Reduced Plate-Out and Bloom”; having application Ser. No. 62/508,770; and filed on May 19, 2017. The subject matter of U.S. provisional patent application 62/508,770 is hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Polymer stabilizers reduce polymer degradation during high-temperature processing. They can also improve a polymer composition's post-processing performance in the field; non-limiting examples of improved polymer-composition field-performance characteristics include increased resistance to thermal and light degradation. Additives, neutralizing agents, or combinations thereof are commonly added to polymer compositions to improve performance in the field.

Polymer additives can sometimes negatively impact a polymer-composition's physical properties and general appearance. For example, a polymer composition's antioxidants or neutralizing agents may cause plate out, blooming, or both. “Plate out” refers to a polymer-composition residue accumulating on one or more surfaces of one or more pieces of equipment during polyolefin-film fabrication or polyolefin-article fabrication, [e.g. residues can include phosphite and oxidized phosphite residues, or residue mass derived from octadecyl-3-(3, 5-di-tert butyl-4-hydroxyphenyl)-propionate, or an acid derivative of one or more neutralizing agents, such calcium stearate or zinc stearate, or residue mass, such as stearic-acid residue mass]. “Bloom(ing)” refers to the migration of one or more residues, e.g. phosphite and oxidized phosphite residues, or residue mass derived from pentaerythritol tetrakis(3-(3,5-ditert-butyl-4-hydroxyphenyl)propionate), from one or more additive materials to the exterior surface of a film or fabricated article. As a result or plate out or bloom, production lines may be required to shutdown to take appropriate measures to remove accumulated residual deposits from the surface of equipment. Any resulting continuous maintenance creates additional undesired cost; thus, it is desired to minimize plate out and blooming.

Stabilizer additives that are prone to blooming include solid phosphites used as secondary antioxidants to protect a polymer from degradation during processing. Non-limiting examples of solid phosphites are: tris(2,4-ditert-butylphenyl)phosphite (CAS #31570-04-4 (e.g., Irgafos 168)), bis(2,4-di-tert-butylphenyl) pentaerythritol diphosphite (CAS #26741-53-7 (e.g., Ultranox 626)), and bis(2, 4-dicumylphenyl)pentaerythritol (CAS #154862-43-8 (e.g. Doverphos 9228). Solid phosphites are therefore typically not included into polyolefin-film compositions because of blooming and plate-out issues associated therewith.

Tris Nonylphenol Phosphite (TNPP) has been the primary low cost liquid phosphite stabilizer used in the plastic and rubber industry. Recently, however, plastic and rubber manufactures have been reluctant to use TNPP in their formulation due to concerns that one of the degradation products of TNPP (nonylphenol) may be xenoestrogenic. Due to this concern about nonylphenol, it is advantageous to use a liquid phosphite that does not contain nonylphenol.

There is therefore a need to have a liquid-phosphite antioxidant suitable for polyolefin applications that are free of alkylphenols that are potentially xenoestrogenic. There is also a need to have a liquid-phosphite antioxidant that satisfies market demand and regulatory schemes around the world. It is also desirable to have a liquid phosphite because a liquid phosphite is less prone to bloom or some other form of incompatibility. Having a liquid phosphite that is more effective at lower concentrations is also desirable because a lower concentration of an additive often makes it less likely to migrate, and a lower concentration reduces the additive's overall production cost.

### BRIEF SUMMARY OF THE INVENTION

A composition having a film having linear low density polyethylene and a first antioxidant component that is:

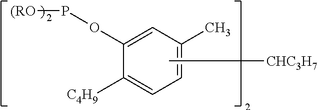

wherein each R moiety is independently selected and is a C8-C20 alkyl moiety.

A composition having a film having linear low density polyethylene and a first antioxidant component that is:

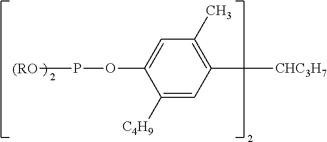

wherein each R moiety is independently selected and is a C8-C20 alkyl moiety.

A composition having a film having linear low density polyethylene and three antioxidant components:

the first antioxidant component being:

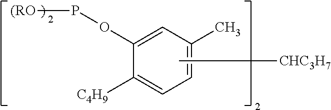

wherein each R moiety is independently selected and is a C11 alkyl moiety;

the second antioxidant component being:

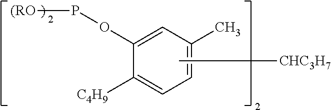

wherein each R moiety is independently selected and is a C12 alkyl moiety; and

a third antioxidant component being:

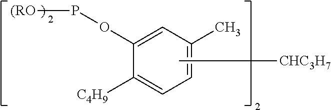

wherein each R moiety is independently selected and is a C13 alkyl moiety.

A composition having a film having linear love density polyethylene and three antioxidant components:

the first antioxidant component being:

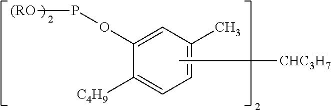

wherein each R moiety is independently selected and is a C14 alkyl moiety;

the second antioxidant component being:

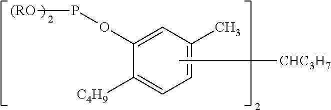

wherein each R moiety is independently selected and is a C15 alkyl moiety; and

a third antioxidant component being:

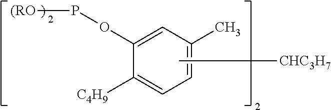

wherein each R moiety is independently selected and is a C16 alkyl moiety.

A composition having a film having linear low density polyethylene and two antioxidant components:

the first antioxidant component being:

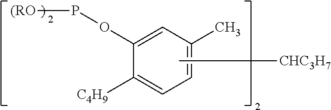

wherein each R moiety is independently selected and is a C13 alkyl moiety; and

the second antioxidant component being:

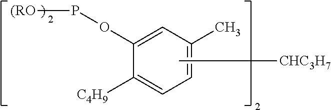

wherein each R moiety is independently selected and is a C14 alkyl moiety.

A composition having a film having linear low density polyethylene and six antioxidant components:

the first antioxidant component being:

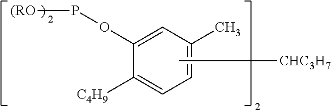

wherein each R moiety is independently selected and is a C11 alkyl moiety;

the second antioxidant component being:

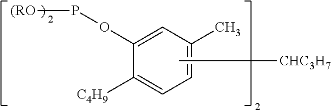

wherein each R moiety is independently selected and is a C12 alkyl moiety;

the third antioxidant component being:

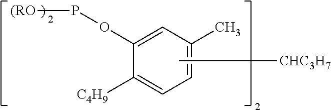

wherein each R moiety is independently selected and is a C13 alkyl moiety;

the fourth antioxidant component being:

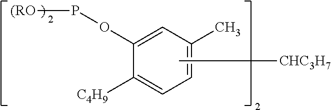

wherein each R moiety is independently selected and is a C14 alkyl moiety;

the fifth antioxidant component being:

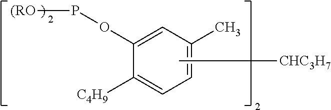

wherein each R moiety is independently selected and is a C15 alkyl moiety; and

the sixth antioxidant component being:

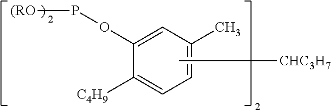

wherein ac R moiety is independently selected and is a C16 alkyl moiety.

Embodiments are directed to antioxidant-stabilized polyolefin polymer compositions, such as polyethylene-based or polypropylene-based compositions, that have excellent color and melt-flow stability properties, that have relatively reduced plate out, and that can be used to manufacture films having relatively reduced blooming compared to known polyolefin-polymer compositions stabilized with different antioxidant compositions. More specifically, and compared to other known compositional embodiments, both film and molded articles manufactured from the inventive compositional embodiments have relatively reduced total phosphite and oxidized phosphite residue mass on a surface of a film or part. Compositional embodiments that include polypropylene have relatively improved stability properties (color and melt flow) and no plate out or blooming from plaques on aging.

In the compositional embodiments, liquid phosphite phosphorous acid, butylidenebis[2-(1,1-dimethylene)-5-methyl-4,1-phenylene]tetraalkylester having the formula:

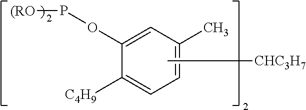

wherein each R moiety is independently selected and is a C8-C20 alkyl moiety; is generally much more compatible with a polyolefin polymer than other commercially available mono-phosphites such as solid tris(2,4-di-t-butylphenol)phosphite (TTBP) and tris(nonylphenol)phosphite (TNPP). The improved compatibility of liquid phosphite phosphorous acid, butylidenebis[2-(1,1-dimethylene)-5-methyl-4,1-phenylene]tetraalkylester having the formula:

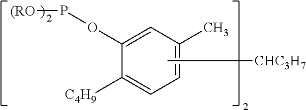

wherein each R moiety is independently selected and is a C8-C20 alkyl moiety, offers several distinct advantages over traditional monophosphites. Solid phosphites such as TTBP are known to exude from the polymer film and must be used at lower concentrations to minimize buildup on processing equipment. Additionally such solid monophosphites may exude to the surface of the polymer post-processing forming a layer of dust on the film surface.

Liquid mono-phosphites such as TNPP do not typically exude from a polyolefin polymer during processing or post processing. However it is still desirable to have a more compatible phosphite since much of the commercial polyolefin film that is produced is used for food packaging and when in use, the film may come into direct contact with food. It is known that whatever additives are contained in the polymer film have the potential to migrate from the polymer and into the food it contacts. The higher molecular weight of phosphite phosphorous acid, butylidenebis[2-(1,1-dimethylene)-5-methyl-4,1-phenylene]tetraalkylester having the formula:

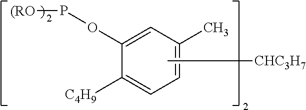

wherein each R moiety is independently selected and is a C8-C20 alkyl moiety, exhibits far lower migration when in contact with food because of the relatively higher molecular weight. Furthermore, phosphite phosphorous acid, butylidenebis[2-(1,1-dimethylene)-5-methyl-4,1-phenylene]tetraalkylester having the formula:

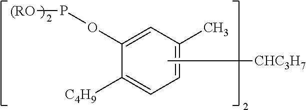

wherein each R moiety is independently selected and is a C8-C20 alkyl moiety, does not contain any xenoestrogenic alkylphenols.

Polyolefin film compositions containing phosphite phosphorous acid, butylidenebis[2-(1,1-dimethylene)-5-methyl-4,1-phenylene]tetraalkylester having the formula:

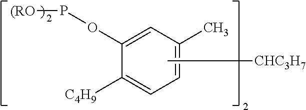

wherein each R moiety is independently selected and is a C8-C20 alkyl moiety, also exhibit improved color stabilization in comparison to polyolefin films containing TNPP and TTBP. The improved color properties are evident during melt processing as well as post processing. During melt processing, the color, as measured by the Yellowness Index (YI) of the polymer, may increase from the shear and heat degradation do to the extrusion or film production process. The polyolefin compositions containing phosphite phosphorous acid, butylidenebis[2-(1,1-dimethylene)-5-methyl-4,1-phenylene]tetraalkylester having the formula:

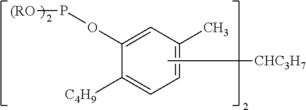

wherein each R moiety is independently selected and is a C8-C20 alkyl moiety, produce a polyolefin film of lower color (YI) when used at equal loading levels or even when used at lower loading levels relative to films containing TNPP and TTBP.

Polyolefin films can also be exposed to elevated temperatures post processing. Elevated post-processing temperatures degrade the polymer causing both color increase and decrease of a polymer's mechanical properties. The polyolefin compositions containing phosphite phosphorous acid, butylidenebis[2-(1,1-dimethylene)-5-methyl-4,1-phenylene]tetraalkylester having the formula:

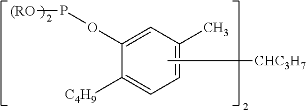

wherein each R moiety is independently selected and is a C8-C20 alkyl moiety, offer equal or slightly better performance for inhibiting a decrease in mechanical properties while at the same time providing superior protection against color increase.

During film processing, it is common for small gels to form due to crosslinking of a polyolefin. Polyolefin compositions containing phosphite phosphorous acid, butylidenebis[2-(1,1-dimethylene)-5-methyl-4,1-phenylene]tetraalkylester having the formula:

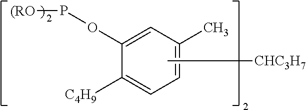

wherein each R moiety is independently selected and is a C8-C20 alkyl moiety, offer improved protection against the formation of gels when compared to polyolefin compositions containing TNPP or TTBP.

Additionally the polyolefin compositions containing FIG. 1 phosphite of current invention offer a synergy with tocophenols (Vitamin E) when used in combination to stabilize a polymer. It is known in the art that Vitamin E is an excellent polymer stabilizer that can be used at a fraction of the loading level of many hindered phenol stabilizers. However it is not commonly used as a stabilizer in polyolefin films since it has the tendency to cause greatly increased color when used with traditional phosphites like TNPP and TTBP. Furthermore, polyolefin compositions containing phosphite phosphorous acid, butylidenebis[2-(1,1-dimethylene)-5-methyl4,1-phenylene]tetraalkylester having the formula:

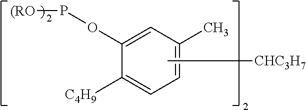

wherein each R moiety is independently selected and is a C8-C20 alkyl moiety, offer such improved color stability (relative to films that don't contain the phosphite phosphorous acid) that vitamin E can be included within the composition to produce a film with better color than traditional antioxidant packages using hindered phenols and TNPP or TTBP.

### BRIEF DESCRIPTION OF THE SEVERAL VIEWS OF THE DRAWING(S)

FIG. 1 shows an apparatus configuration useful for manufacturing a useful phosphite compound.

FIG. 2 is a graph showing physical properties of an embodiment.

FIG. 3 is a graph showing physical properties of an embodiment.

FIG. 4 is a graph showing physical properties of an embodiment.

FIG. 5 is a graph showing physical properties of an embodiment.

FIG. 6 is a bar chart showing physical properties of an embodiment.

### DETAILED DESCRIPTION OF THE INVENTION

Very generally, compositional embodiments include compositions having a polyolefin polymer and a specific antioxidant within the polymer; application embodiments are also directed to using the compositional embodiments in traditional polymer applications that include film and injection-molding applications.

More specifically, embodiments include polyolefin compositions having: i) a polyolefin polymer, such as an ethylene-based polymer or a propylene-based polymer, in combination with ii) an antioxidant that is phosphite phosphorous acid, butylidenebis[2-(1,1-dimethylene)-5-methyl-4,1-phenylene]tetraalkylester having the formula:

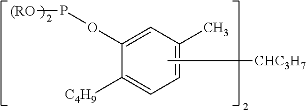

wherein each R moiety is independently selected and is a C8-C20 alkyl moiety. In embodiments, each R moiety is independently selected and is a linear or branched alkyl moiety; furthermore, it is a C8, C9, C10, C11, C12, C13, C14, C15, C16, C17, C18, C19, or C20 alkyl moiety. In other embodiments, each R moiety is independently selected and is a branched C13 alkyl moiety.

Compositional embodiments that include linear-low density polyethylene are useful in film applications, and compositional embodiments that include polypropylene are useful in non-film applications such as injection-molding applications.

In embodiments, useful forms of phosphite phosphorous acid, butylidenebis[2-(1,1-dimethylene)-5-methyl-4,1-phenylene]tetraalkylester include:

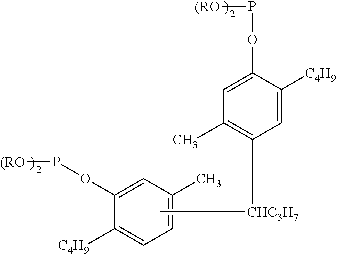

wherein each R moiety is independently selected and is a C8-C20 alkyl moiety. In an embodiment, each R moiety is a C13 alkyl moiety. In another embodiment, each R moiety is a C13 branched alkyl moiety.

Additional embodiments are directed to polyolefin compositions that include polyolefin polymers, such as ethylene-based or propylene-based polymers, and an antioxidant that is phosphite phosphorous acid, butylidenebis[2-(1,1-dimethylene)-5-methyl-4,1-phenylene]tetraalkylester having the formula:

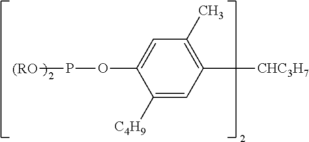

wherein each R moiety is independently selected and is a C8-C20 alkyl moiety. In embodiments, each R moiety is independently selected and is a linear or branched alkyl moiety; furthermore, it is a C8, C9, C10, C11, C12, C13, C14, C15, C16, C17, C18, C19, or C20 alkyl moiety. In an embodiment, each R moiety is a C13 alkyl moiety. In another embodiment, each R moiety is a C13 branched alkyl moiety.

Application embodiments are directed to a film having linear low density polyethylene and three antioxidant components:

the first antioxidant component being:

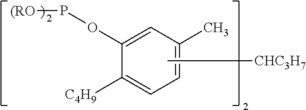

wherein each R moiety is independently selected and is a C11 alkyl moiety;

the second antioxidant component being:

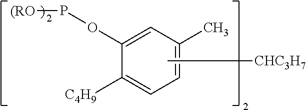

wherein each R moiety is independently selected and is alkyl moiety; and

a third antioxidant component being:

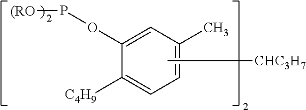

wherein each R moiety is independently selected and is a C13 alkyl moiety. In embodiments, the first, second, and third antioxidant components each have an R moiety that is branched.

Additional application embodiments are directed to a film having linear low density polyethylene and three antioxidant components,

the first antioxidant component being:

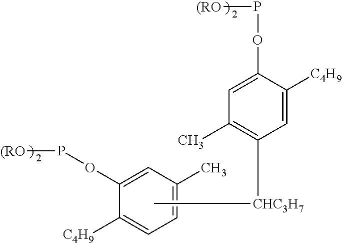

wherein each R moiety is independently selected and is a C11 alkyl moiety;

the second antioxidant component being:

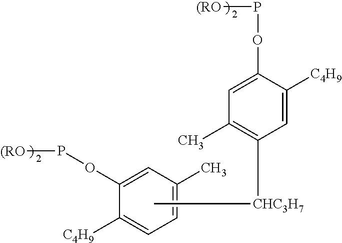

wherein each R moiety is independently selected and is a C12 alkyl moiety; and

the third antioxidant component being:

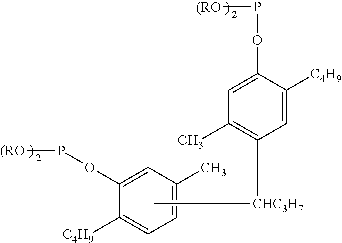

wherein each R moiety is independently selected and is a C13 alkyl moiety. In embodiments, the first, second, and third antioxidant components each have an R moiety that is branched.

Additional application embodiments are directed to a film having linear low density polyethylene and three antioxidant components,

the first antioxidant component is:

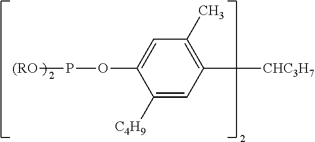

wherein each R moiety is independently selected and is a C11 alkyl moiety;

the second antioxidant component is:

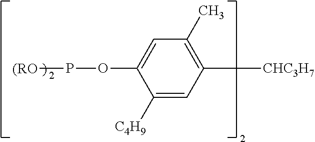

wherein each R moiety is independently selected and is a C12 alkyl moiety; and

the third antioxidant component is:

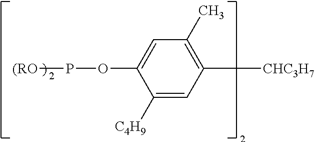

wherein each R moiety is independently selected and is a C13 alkyl moiety. In embodiments, the first, second, and third antioxidant components each have an R moiety that is branched.

Additional application embodiments are directed to a film having linear low density polyethylene and three antioxidant components:

the first antioxidant component being:

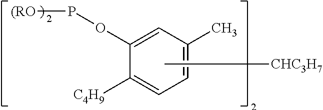

wherein each R moiety is independently selected and is a C14 alkyl moiety;

the second antioxidant component being:

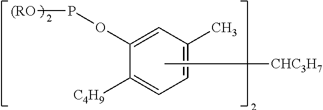

wherein each R moiety is independently selected and is a C15 alkyl moiety; and

the third antioxidant component being:

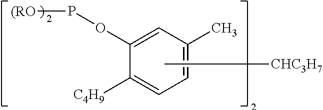

wherein each R moiety is independently selected and is a C16 alkyl moiety. In embodiments, the first, second, and third antioxidant components each have an R moiety that is branched.

Additional film embodiments are directed to a film having linear low density polyethylene and three antioxidant components:

the first antioxidant component is:

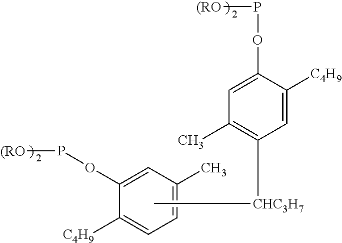

wherein each R moiety is independently selected and is a C14 alkyl moiety;

the second antioxidant component is:

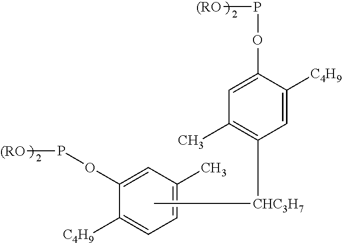

wherein each R moiety is independently selected and is a C15 alkyl moiety; and

the third antioxidant component is:

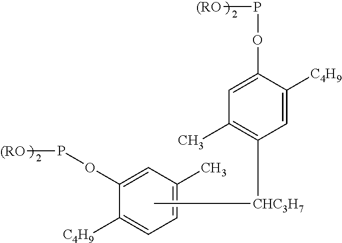

wherein each R moiety is independently selected and is a C16 alkyl moiety. In embodiments, the first, second, and third antioxidant components each have an R moiety that is branched.

Additional application embodiments are directed to a film having linear low density polyethylene and three antioxidant components:

the first antioxidant component is:

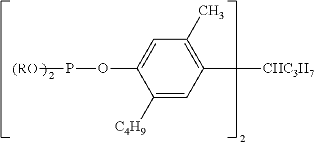

wherein each R moiety is independently selected and is a C14 alkyl moiety;

the second antioxidant component is:

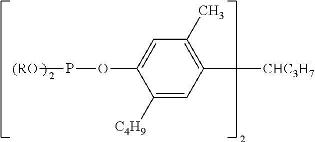

wherein each R moiety is independently selected and is a C15 alkyl moiety; and

the third component is:

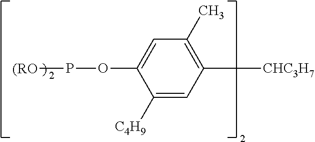

wherein each R moiety is independently selected and is a C16 alkyl moiety. In embodiments, the first, second, and third antioxidant components each have an R moiety that is branched.

Additional application embodiments are directed to a film having linear low density polyethylene and two antioxidant components:

the first antioxidant component being:

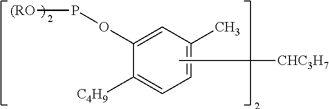

wherein each R moiety is independently selected and is a C13 alkyl moiety; and

the second antioxidant component being:

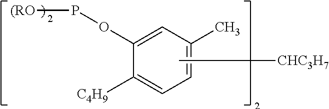

wherein each R moiety is independently selected and is a C14 alkyl moiety. In embodiments, the first and second antioxidant components each have an R moiety that is branched.

Additional application embodiments are directed to a film having linear low density polyethylene and two antioxidant components:

the first antioxidant component is:

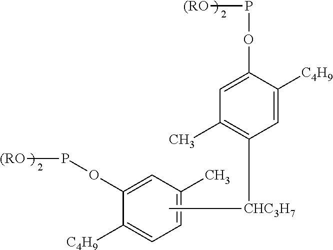

wherein each R moiety is independently selected and is a C13 alkyl moiety; and

the second antioxidant component is:

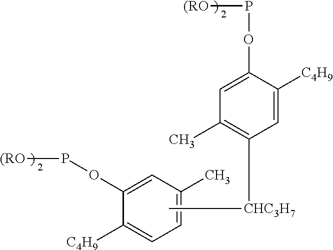

wherein each R moiety is independently selected and is a C14 alkyl moiety. In embodiments, the first and second antioxidant components each have an R moiety that is branched.

Additional application embodiments are directed to a film having linear low density polyethylene and two antioxidant components:

the first antioxidant component is:

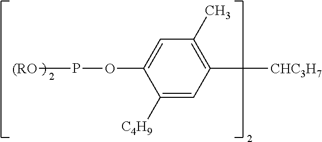

wherein each R moiety is independently selected and is a C13 alkyl moiety; and

the second antioxidant component is:

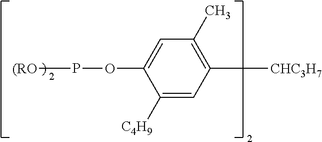

wherein each R moiety is independently selected and is a C14 alkyl moiety. In embodiments, the first and second antioxidant components each have an R moiety that is branched.

Additional application embodiments are directed to a film having linear low density polyethylene and six antioxidant components:

the first antioxidant component being:

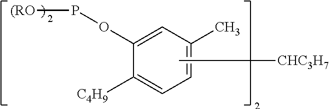

wherein each R moiety is independently selected and is a C11 alkyl moiety;

the second antioxidant component being:

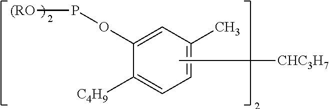

wherein each R moiety is independently selected and is a C12 alkyl moiety;

the third antioxidant component being:

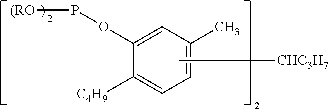

wherein each R moiety is independently selected and is a C13 alkyl moiety;

the fourth antioxidant component being:

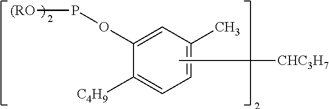

wherein each R moiety is independently selected and is a C14 alkyl moiety;

the fifth antioxidant component being:

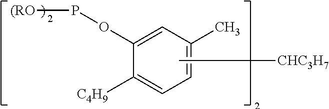

wherein each moiety is independently selected and is a C15 alkyl moiety; and

the sixth antioxidant component being:

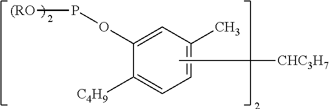

wherein each R moiety is independently selected and is a C16 alkyl moiety. In embodiments, each of the six antioxidant components has an R moiety that is branched.

Additional application embodiments are directed to a film having linear low density polyethylene and six antioxidant components:

the first antioxidant component is:

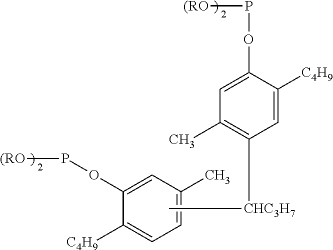

wherein each R moiety is independently selected and is a C11 alkyl moiety;

the second antioxidant component is:

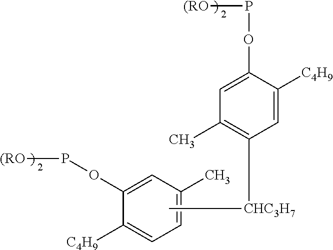

wherein each moiety is independently selected and is a C12 alkyl moiety;

the third antioxidant component is:

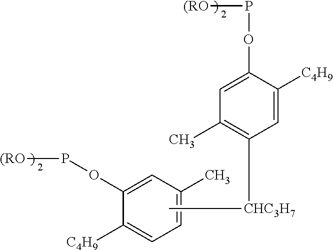

wherein each R moiety is independently selected and is a C13 alkyl moiety,

the fourth antioxidant component is:

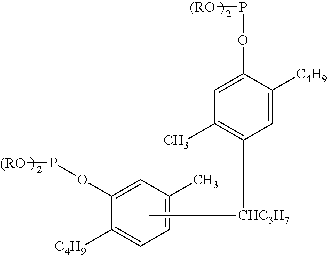

wherein each R moiety is independently selected and is a C14 alkyl moiety; and

the fifth antioxidant component is:

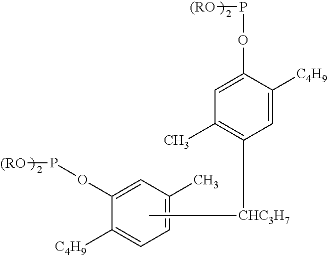

wherein each R moiety is independently selected and is a C15 alkyl moiety; and

the sixth antioxidant component is:

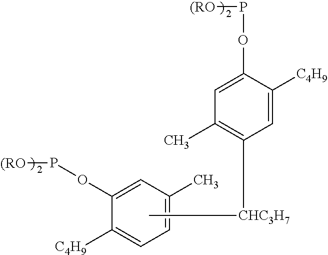

wherein each R moiety is independently selected and is a C16 alkyl moiety. In embodiments, each of the six antioxidant components has an R moiety that is branched.

Additional application embodiments are directed to a film having linear low density polyethylene and six antioxidant components:

the first antioxidant component is:

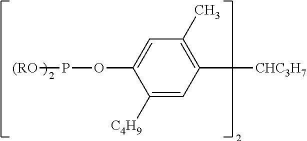

wherein each R moiety is independently selected and is a C11 alkyl moiety;

the second antioxidant component is:

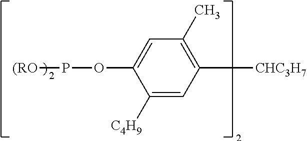

wherein each R moiety is independently selected and is a C12 alkyl moiety; and

the third component is:

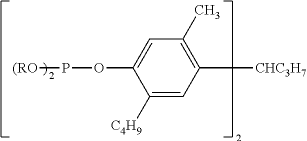

wherein each R moiety is independently selected and is a C13 alkyl moiety;

the fourth antioxidant component is:

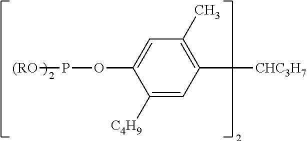

wherein each R moiety is independently selected and is a C14 alkyl moiety; and

the fifth antioxidant component is:

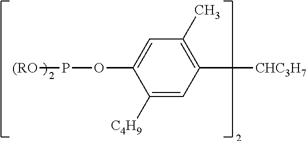

wherein each R moiety is independently selected and is a C15 alkyl moiety;

the sixth antioxidant component is:

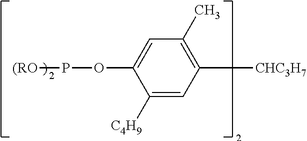

wherein each R moiety is independently selected and is a C16 alkyl moiety. In embodiments, each of the six antioxidant components has an R moiety that is branched.

Films manufactured using the compositional embodiments that include linear low density polyethylene can be manufactured using any known film-manufacturing process. A non-limiting list of known film-manufacturing processes include blown-film processes and cast-film processes.

In any embodiment described herein, a Ziegler Natta catalyzed LLDPE can be used to make a film. In any embodiment described herein, a chrome catalyzed LLDPE can be used to make a film. In any embodiment described herein, a metallocene catalyzed LLDPE can be used to make a film. In any embodiment described herein, other known LLDPE catalysts can be used to manufacture LLDPE useful for making any of the above film embodiments. Catalysis, during the manufacture of LLDPE, with any of the above-identified catalysts can take place in any of the following phases: gas, solution, or slurry.

In embodiments a film is manufactured from a Ziegler Natta catalyzed LLDPE having an MI ranging from 0.5 to 1.0; and in other embodiments, a Ziegler Natta catalyzed LLDPE MI ranges from 0.5 to 5.0.

Films manufactured using the compositional embodiments that include linear low density polyethylene have a thickness ranging from 0.05 mils to 5 mils. In other embodiments, the film thickness ranges from 0.05 mils to 20 mils. Persons of ordinary skill in the art will appreciate that 1 mil=0.001 inches.

Additional embodiments are directed to a composition having polypropylene and a first antioxidant component that is:

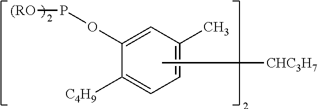

wherein each R moiety is independently selected and is a C8-C20 alkyl moiety. In an embodiment, each R is independently selected and is a C13 alkyl moiety. In an embodiment, each R is independently selected and is a branched C13 alkyl moiety.

In another embodiment, the composition has polypropylene and the first antioxidant component is:

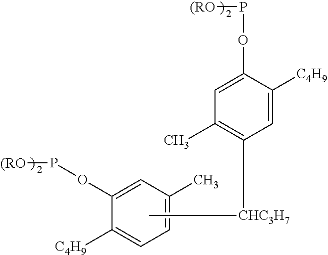

wherein each R moiety is independently selected and is a C8-C20 alkyl moiety. In an embodiment, each R is independently selected and is a C13 alkyl moiety. In an embodiment, each R is independently selected and is a branched C13 alkyl moiety.

In another embodiment, the composition has polypropylene and the first antioxidant component is:

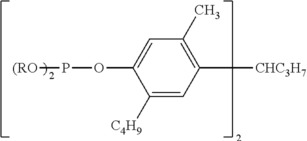

wherein each R moiety is independently selected and is a C8-C20 alkyl moiety. In an embodiment, each R is independently selected and is a C13 alkyl moiety. In an embodiment, each R is independently selected and is a branched C13 alkyl moiety.

Other polypropylene embodiments are directed to a polypropylene composition having three antioxidant components:

the first antioxidant component being:

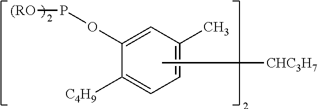

wherein each R moiety is independently selected and is a C11 alkyl moiety;

the second antioxidant component being:

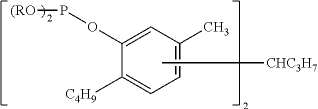

wherein each R moiety is independently selected and is a C12 alkyl moiety; and

the third antioxidant component being:

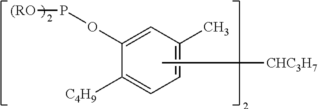

wherein each R moiety is independently selected and is a C13 alkyl moiety. In an embodiment, the first, second, and third antioxidant components each have an R moiety that is branched.

Still other polypropylene embodiments are directed to a polypropylene composition having three antioxidant components:

the first antioxidant component is:

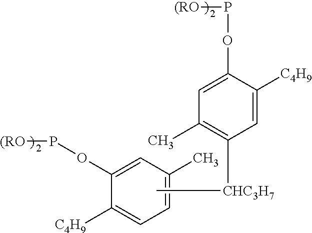

wherein each R moiety is independently selected and is a C11 alkyl moiety;

the second antioxidant component is:

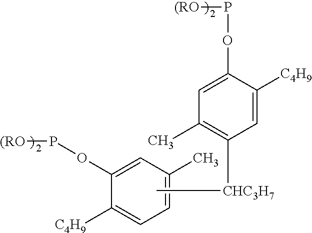

wherein each R moiety is independently selected and is a C12 alkyl moiety; and

the third antioxidant component is:

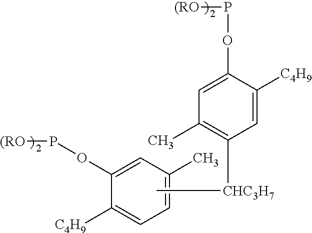

wherein each R moiety is independently selected and is a C13 alkyl moiety. In an embodiment, the first, second, and third antioxidant components each have an R moiety that is branched.

Still other polypropylene embodiments are directed to a polypropylene composition having three antioxidant components:

the first antioxidant component is:

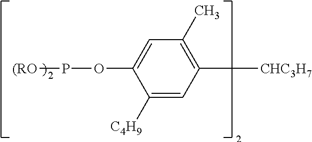

wherein each R moiety is independently selected and is a C11 alkyl moiety;

the second antioxidant component is:

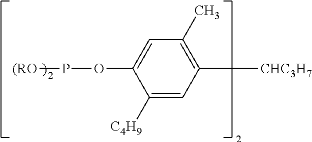

wherein each R moiety is independently selected and is a C12 alkyl moiety; and

the third antioxidant component is:

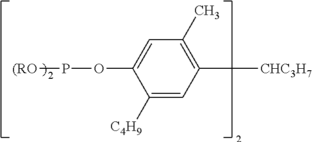

wherein each R moiety is independently selected and is a C13 alkyl moiety. In an embodiment, the first, second, and third antioxidant components each have an R moiety that is branched.

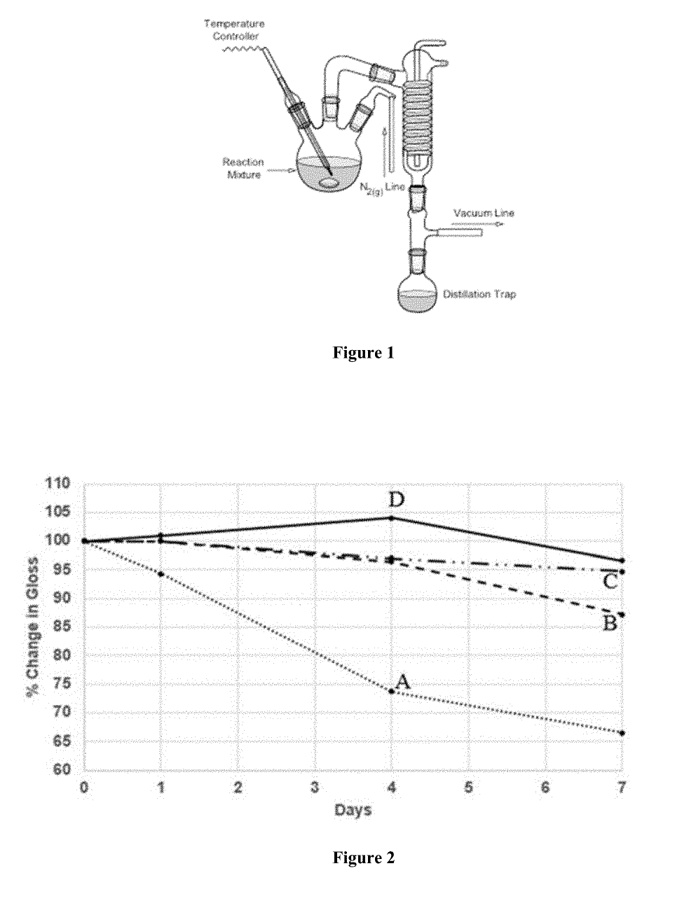

In one embodiment, the instant invention provides a polyethylene composition suitable for film applications comprising the melt blending product of: (a) an ethylene-based polymer; (b) a first antioxidant system comprising one or more antioxidants selected from the group consisting of octadecyl-3-(3,5-di-tert.butyl-4-hydroxyphenyl)-propionate; pentaerythritol tetrakis (3-(3,5-di-tert-butyl-4-hydroxyphenyl)propionate); and combinations thereof; (c) a second antioxidant system comprising a liquid phosphite corresponding to the formula phosphorous acid, butylidenebis[2-(1,1-dimethylene)-5-methyl-4,1-phenylene]tetraalkylester, (FIG. 1) (d) optionally one or more neutralizing agents. In an alternative embodiment, the instant invention further provides a film comprising a polyethylene composition comprising the melt blending product of: (a) an ethylene based polymer; (b) a first antioxidant system comprising one or more antioxidants selected from the group consisting of octadecyl-3-(3,5-di-tert.butyl-4-hydroxyphenyl)-propionate; pentaerythritol tetrakis (3-(3,5-di-tert-butyl-4-hydroxyphenyl)propionate); and combinations thereof; (c) a second antioxidant system comprising a liquid phosphite corresponding to the formula phosphorous acid, butylidenebis[2-(1,1-dimethylene)-5-methyl-4,1-phenylene]tetraalkylester and (d) optionally one or more neutralizing agents.

The instant invention provides a polypropylene composition suitable for molded or film applications comprising the melt blending product of: (a) an polypropylene based polymer; (b) a first antioxidant system comprising one or more antioxidants selected from the group consisting of octadecyl-3-(3,5-di-tert.butyl-4-hydroxyphenyl)-propionate; pentaerythritol tetrakis (3-(3,5-di-tert-butyl-4-hydroxyphenyl)propionate); and combinations thereof; (c) a second antioxidant system comprising a liquid phosphite corresponding to the formula phosphorous acid, butylidenebis[2-(1,1-dimethylene)-5-methyl-4,1-phenylene]tetraalkylester, (d) optionally one or more neutralizing agents.

In embodiments, 0.001 to about 5 weight percent of the compositional embodiments are made up of one or more antioxidant components having the formula:

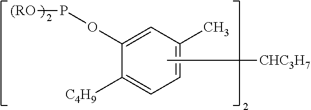

wherein each R moiety is independently selected and is a C8-C20 alkyl moiety. In other embodiments, 0.01 to 2.0 weight percent of the compositional embodiments are made up of one or more antioxidant components having the formula:

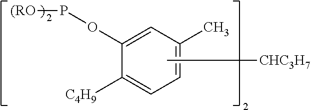

wherein each R moiety is independently selected and is a C8-C20 alkyl moiety. In other embodiments, 0.025 to 1 weight percent of the compositional embodiments are made up of one or more antioxidant components having the formula:

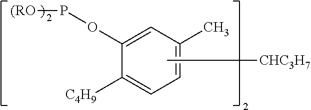

each R moiety is independently selected and is a C8-C20 alkyl moiety.

In the above-mentioned compositional embodiments, any of the antioxidant components having the formula:

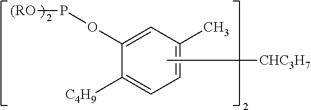

wherein each R moiety is independently selected and is a C8-C20 alkyl moiety;
can be added to a polyolefin-polymer composition at any point during melt processing or injection molding using known methods. In embodiments, the phosphite phosphorous acid, butylidenebis[2-(1,1-dimethylene)-5-methyl-4,1-phenylene]tetraalkylester having the formula:

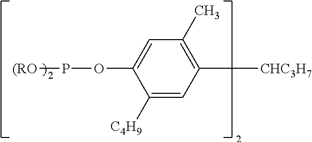

wherein each R moiety is independently selected and is a C8-C20 alkyl moiety, is in a liquid form when added to a polyolefin polymer. As a non-limiting example, the above-described compositional embodiments that include an antioxidant, i.e., phosphite phosphorous acid, butylidenebis[2-(1,1-dimethylene)-5-methyl-4,1-phenylene]tetraalkylester, can be manufactured by standard polyolefin processes such as melt blending, extruding to produce a film or injection molding to form a molded plaque. Furthermore, one of ordinary skill in the art will be able to successfully add one or more of the antioxidant components to a polyolefin-polymer composition during melt processing or injection molding without having to exercise undue experimentation.

A non-limiting list of polyolefin polymers useful in the above-described embodiments includes: polymers of monoolefins and diolefins such as polyethylene, polypropylene, polyisobutylene, poly-1-butene, poly-4-methylpentene, polyisoprene, polybutadiene, for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), and polymers of cycloolefins such as cyclopentene and norbornene, and blends thereof. Additional useful polymers include copolymers of monoolefins and diolefins with each other or with other vinyl monomers such as ethylene/propylene, propylene/1-butene, propylene/isobutene, propylene/butadiene, ethylene/1-butene, ethylene/1-hexene, ethylene/1-octene, isobutylene/isoprene, ethylene/alkylacrylates, ethylene/alkylmethacrylates, ethylene/vinyl acetate, ethylene/acrylic acid (and salts, ionomers, thereof), terpolymers of ethylene, propylene, and dienes such as hexadiene, dicyclopentadiene, and ethylene-norbornene, and blends thereof. Any of the listed polyolefin polymers can be used alone or in combination.

In addition to phosphite phosphorous acid, butylidenebis[2-(1,1-dimethylene)-5-methyl-4,1-phenylene]tetraalkylester, any other known polymer additive or filler may be added to any of the above compositional embodiments. In embodiments, other known stabilizers, in addition to phosphite phosphorous acid, butylidenebis[2-(1,1-dimethylene)-5-methyl-4,1-phenylene]tetraalkylester, can make up from about 0.001% to 5%, from 0.01% to 2%, or from 0.025% to 1% of the compositional embodiment.

A non-limiting list of useful known stabilizers that can also make up part of the compositional embodiments include:
i) conventional stabilizers listed below or in Chemical Additives for the Plastic Industry, by Radian Corporation, Noyes Data Corporation NJ, published 1987, hereafter referred to as Chemical Additives;
ii) Hindered phenolic antioxidants such as 2,6-di-tert-butyl-4-methylphenol; octadecyl 3,5-di-tert-butyl-4-hydroxy-hydrocinnamate; tetrakis methylene (3,5-di-tert-butyl-4-hydroxyhydrocinnamate)methane; and tris(3,5-di-tert-butyl-4-hydroxybenzyl) isocyanate. Other phenolic antioxidants are listed in Chemical Additives, pages 152 to 163;
iii) Thioesters such as dilauryl thiodipropionate and distearyl thiodipropionate. Other thioesters are listed in Chemical Additives, page 152 to 163;
iv) Aromatic amine stabilizers such as N, N′-diphenyl-p-phenylene-diamine. Other aromatic amine stabilizers are listed in Chemical Additives, pages 152 to 163;
v) Hindered amine light stabilizers, known as HALS, such as bis-(2,2,6,6-tetramethylpiperidyl) sebacate, condensation product of N,N′-(2,2,6,6-tetramethylpiperidyl)-hexamethylenediamine and 4,4-octylamino-2,6-dichloro-s-triazine, and the condensation product of N,N′-(2,2,6,6-tetramethylpiperidyl)-hexamethylenediamine and 4-N-morpholinyl-2,6-dichloro-s-triazine. Other HALS are listed in Chemical Additives, pages 660-666;
vi) UV absorbers such as 2-hydroxy-4-n-octyloxybenzophenone, 2(2′-hydroxy-5′-methylphenyl)-benzotriazole, and 2(2′-hydroxy-5-t-octylphenyl)-benzotriazole. Other UV stabilizers are listed in Chemical Additives, pages 660-666;
vii) Phosphites such as tris(2,4-di-tert-butylphenyl)phosphite, distearyl pentaerythritol diphosphite, and 2,4-dicumylphenyl pentaerythritol diphosphite. Other phosphites are listed in Chemical Additives, pages 152 to 163;
viii) Acid neutralizers such as calcium stearate, zinc stearate, calcium lactate, calcium stearyl lactate, epoxidized soybean oil, and hydrotalcite (natural and synthetic);
ix) other additives such as lubricants, antistatic agents, antiblocking agents, slip agents, fire retardants, nucleating agents, impact modifiers, blowing agents, plasticizers, fillers, dyes, and pigments may be used in an amount appropriate and in combination of the invented polymeric phosphites to modify a selected property of the polymer. These and other additives can be found listed in Chemical Additives; and
x) alkanol amines such as but not limited to triethanolamine and triisopropanolamine.

Phosphite phosphorous acid, butylidenebis[2-(1,1-dimethylene)-5-methyl-4,1-phenylene]tetraalkylester having the formula:

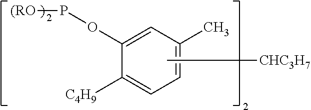

wherein each R moiety is independently selected and is a C8-C20 alkyl moiety, can be used as an antioxidant stabilizer in polyolefin polymer compositions in combination with phenolic antioxidants, light stabilizers, processing stabilizers, and combinations thereof.

Polyolefin-polymer composition embodiments can have both: i) phosphite phosphorous acid, butylidenebis[2-(1,1-dimethylene)-5-methyl-4,1-phenylene]tetraalkylester having the formula:

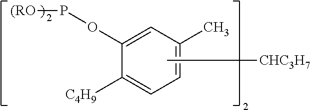

wherein each R moiety is independently selected and is a C8-C20 alkyl moiety, and ii) vitamin E; these compositional embodiments are beneficial for protection against gas fade. This two-component combination within a polyolefin polymer composition is useful for making a film having relatively improved resistance to gas fade.

### EXAMPLES

Examples 1-4 are directed to preparing the following phosphite:

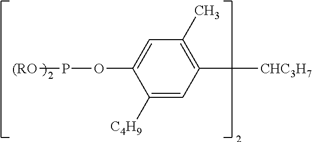

wherein each R is independently selected and is equal to —(CH2)12 CH3 or R═C-13. It is expected that slightly different end products can be obtained depending on the mole ratios used to make this phosphite. The above phosphite may also contain alkanol amines such as but not limited to triethanolamine and triisopropanolamine to give improved hydrolysis resistance.

### Example 1

### Phosphite Standard Charges

The apparatus used consisted of a three-neck 2000 mL flask equipped with a stir bar, temperature controller, nitrogen gas line, and a condenser with distillation trap as depicted in FIG. 1. To the 3-neck flask triphenyl phosphite (527.6 g, 1.70 mol), tridecyl alcohol (662.0 g, 3.31 mol), and 4,4′-butylidenebis[2-(1,1-dimethylethyl)-5-methyl-phenol], BBMC, (289.6 g, 0.756 mol) were added. The mixture was stirred while heating to 50° C. under a nitrogen blanket. Once, the contents were will mixed into a cloudly, opaque single-phased solution, 1.6 g potassium hydroxide was added. The stifling mixture was then heated under nitrogen to 155° C. and then allowed to react for 1 hour. After 1 hour, the nitrogen line was closed and the pressure was then gradually reduced to 1 mmHg while increasing the temperature to 180-185° C. over a course of 2 hours. The reaction contents were held at 180-185° C. under vacuum for 1 additional hour at which point no more phenol was distilling out. The vacuum was then broken by nitrogen and the crude product was cooled to 50° C. The product was then filtered producing a clear, colorless liquid.

### Example 2

### Phosphite with 20 mol % Excess BBMC

The apparatus used consisted of a three-neck 2000 mL flask equipped with a stir bar, temperature controller, nitrogen gas line, and a condenser with distillation trap as depicted in FIG. 1. To the 3-neck flask triphenyl phosphite (527.3 g, 1.69 mol), tridecyl alcohol (662.2 g, 3.31 mol), and 4,4′-butylidenebis[2-(1,1-dimethylethyl)-5-methyl-phenol], BBMC, (347.3 g, 0.907 mol) were added. The mixture was stirred while heating to 50° C. under a nitrogen blanket. Once, the contents were well mixed into a cloudly, opaque single-phased solution, 1.6 g potassium hydroxide was added. The stirring mixture was then heated under nitrogen to 155° C. and then allowed to react for 1 hour. After 1 hour, the nitrogen line was closed and the pressure was then gradually reduced to 1 mmHg while increasing the temperature to 180-185° C. over a course of 2 hours. The reaction contents were held at 180-185° C. under vacuum for 1 additional hour at which point no more phenol was distilling out. The vacuum was then broken by nitrogen and the crude product was cooled to 50° C. The product was then filtered producing a clear, colorless liquid.

### Example 3

### Phosphite with 10 mol % Less BBMC

The apparatus used consisted of a three-neck 2000 mL flask equipped with a stir bar, temperature controller, nitrogen gas line, and a condenser with distillation trap as depicted in FIG. 1. To the 3-neck flask triphenyl phosphite (527.2 g, 1.69 mol), tridecyl alcohol (665.2 g, 3.32 mol), and 4,4′-butylidenebis[2-(1,1-dimethylethyl)-5-methyl-phenol], BBMC, (260.6 g, 0.680 mol) were added. The mixture was stirred while heating to 50° C. under a nitrogen blanket. Once, the contents were will mixed into a cloudly, opaque single-phased solution, 1.6 g potassium hydroxide was added. The stifling mixture was then heated under nitrogen to 155° C. and then allowed to react for 1 hour. After 1 hour, the nitrogen line was closed and the pressure was then gradually reduced to 1 mmHg while increasing the temperature to 180-185° C. over a course of 2 hours. The reaction contents were held at 180-185° C. under vacuum for 1 additional hour at which point no more phenol was distilling out. The vacuum was then broken by nitrogen and the crude product was cooled to 50° C. The product was then filtered producing a clear, colorless liquid.

### Example 4

### 20 mol % Less BBMC

The apparatus used consisted of a three-neck 2000 mL, flask equipped with a stir bar, temperature controller, nitrogen gas line, and a condenser with distillation trap as depicted in FIG. 1. To the 3-neck flask triphenyl phosphite (527.6 g, 1.70 mol), tridecyl alcohol (662.3 g, 3.31 mol), and 4,4′-butylidenebis[2-(1,1-dimethylethyl)-5-methyl-phenol], BBMC, (231.6 g, 0.605 mol) were added. The mixture was stirred while heating to 50° C. under a nitrogen blanket. Once, the contents were will mixed into a cloudly, opaque single-phased solution, 1.6 g potassium hydroxide was added. The stirring mixture was then heated under nitrogen to 155° C. and then allowed to react for 1 hour. After 1 hour, the nitrogen line was closed and the pressure was then gradually reduced to 1 mmHg while increasing the temperature to 180-185° C. over a course of 2 hours. The reaction contents were held at 180-185° C. under vacuum for 1 additional hour at which point no more phenol was distilling out. The vacuum was then broken by nitrogen and the crude product was cooled to 50° C. The product was then filtered producing a clear, colorless liquid.

TABLE 1
Typical properties of oligomeric-BBMC alkyl phosphite.

| Properties | Example 1 | Example 2 | Example 3 | Example 4 |
|---|---|---|---|---|
| mg KOH/g (ASTM | 0.01 | 0.01 | 0.01 | 0.01 |
| D3242) | | | | |
| Specific Gravity @ | 0.945 | 0.947 | 0.94 | 0.939 |
| 25° C. (ASTM D1298) | | | | |
| Refractive Index @ | 1.4943 | 1.4965 | 1.4925 | 1.4914 |
| 25° C. (ASTM D1218) | | | | |
| centiPoise @ 25° C. | 2284.9 | 4718.8 | 1367.4 | 863.1 |

### Example 5

### Compatibility Bloom/Exudation

The compatibility of an additive in the polymer is a major factor when selecting an additive. Additives that are not compatible, exude out of the polymer causing issues during processing and post processing. During processing, additives that are not compatible will plate out on to the processing equipment which can cause delays in production since time must be taken to clean these additives off of the equipment. The time spent cleaning this equipment can be very costly since the equipment often needs to be shut down causing delays in production. Additives may also bloom to the surface of the polymer after processing. This can cause surface defects in the polymer, even causing a fine powder to develop if the additive is a solid.

The amount of additive that is exuding can be measured by surface gloss. The gloss of a polymer surface will decrease as additives exude or bloom to the surface. Gloss measurements were taken using a micro-gloss meter from BYK-Gardner. Measurements were taken at a 60 degree angle and gloss values were recorded. Results are presented as % change in gloss. This is calculated according to the following equation:

(Gloss reading at time interval/initial gloss reading)*100=% change in gloss

Experiments were performed to compare the phosphites of the current invention with tris-di-t-butyl phosphite and Trisnonylphenol phosphite. These were compounded into LLDPE and compression molded into plaques. The phosphite produced in Example 1 was loaded into the polymer at a higher level to emphasize its superior compatibility in the polymer. The compression molded plaques were then aged in an oven at 70 C to accelerate the possible migration of the additives. An initial gloss reading was taken for all of the samples before oven aging. Readings were then taken after 1 day, 4 days, and 7 days of oven aging. This type of oven aging test is commonly used to measure the compatibility of additives in the polymer. It can accurately predict both plate out during processing and bloom post processing.

Comparative Oven Aging Formulations

| | Primary | |
|---|---|---|
| Formulation | Antioxidant | Phosphite |
| A | 500 ppm 1076 | 1500 ppm Tris-di-t-butylphenol phosphite |
| B | 500 ppm 1076 | 2000 ppm Tris Nonylphenol Phosphite |
| C | 500 ppm 1076 | 2000 ppm Example1 |
| D | 500 ppm 1076 | 2500 ppm Example 1 |

As shown in FIG. 2, the surface gloss readings of the polymer containing 1500 ppm tris-di-t-butylphenol phosphite dropped quickly indicating that the additive was exuding to the surface. The Tris-nonyl phenol phosphite showed only a minor drop indicating only a small amount of exudation. The phosphite produced in Example 1 showed essentially no change in surface gloss showing its superior compatibility with the polymer when compared to other commercially available phosphites. This indicates there should be no issues with bloom or exudation during processing or after processing.

### Example 6

### Performance Data

Multi-pass extrusion studies were run to compare the performance of Example 1 vs tris-di-tbutylphenol and Trisnonylphenol. Performance of additives were compared by measuring melt flow index and color, Yellowness Index (YI), of polymer after extrusion passes 1, 3, and 5. When a polymer degrades it may crosslink or chain scission. Performance studies were run in linear low density polyethylene (LLDPE) which is known to crosslink. As the polymer crosslinks the flow through the melt indexer slows due to viscosity of the polymer increasing, and therefore the measured melt index will decrease. Antioxidants help to prevent this type of degradation. An effective antioxidant package will maintain the melt index near the starting value. Antioxidants will also help to prevent the discoloration of the polymer when I degrades. The more effective the AO package the lower the color value on the Yellowness Index (YI) scale.

Tris-nonylphenol phosphite was compared against Example 1 in a 1 MI LLDPE resin. The multi-pass evaluations were carried out on a 26 mm, co-rotating extruder. The additives were compounded into the resin at 205 C under nitrogen. The compounded resin was then extruded for 5 passes, under air, at 250 C. Melt index and color (YI) was measured after the compound pass and after each extrusion pass.

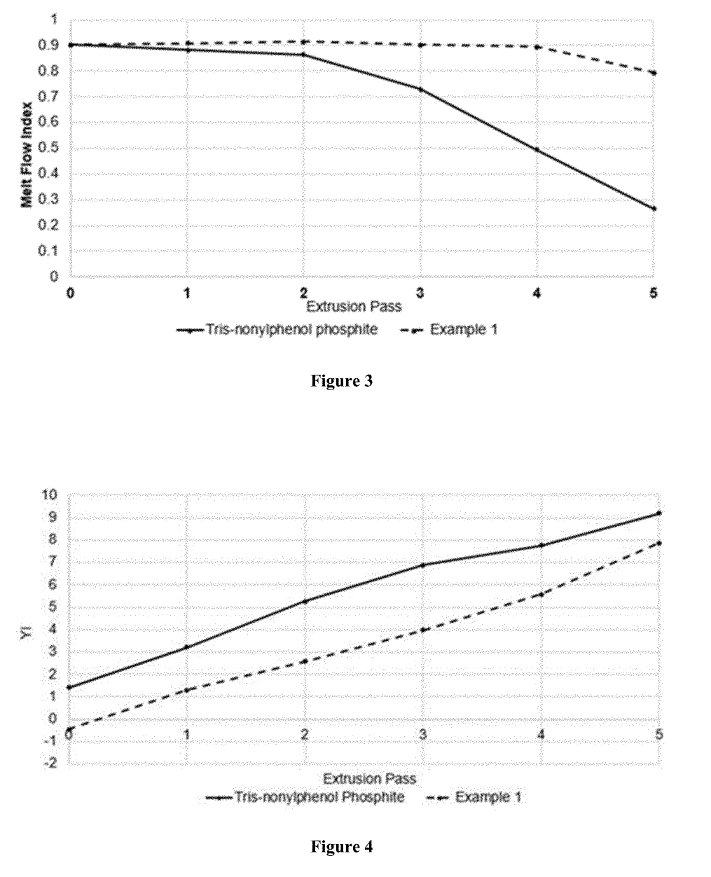

As shown in FIG. 3, Example 1 showed superior stabilization over tris-nonyphenol phosphite. At an equal loading level it was able to maintain the melt index far better over the 5 extrusion passes.

As shown in FIG. 4, Example 1 also maintained color better over the 5 MI passes as shown by the lower YI values. Example 1 showed superior stabilization over bis-di-t-butylphenol phosphite.

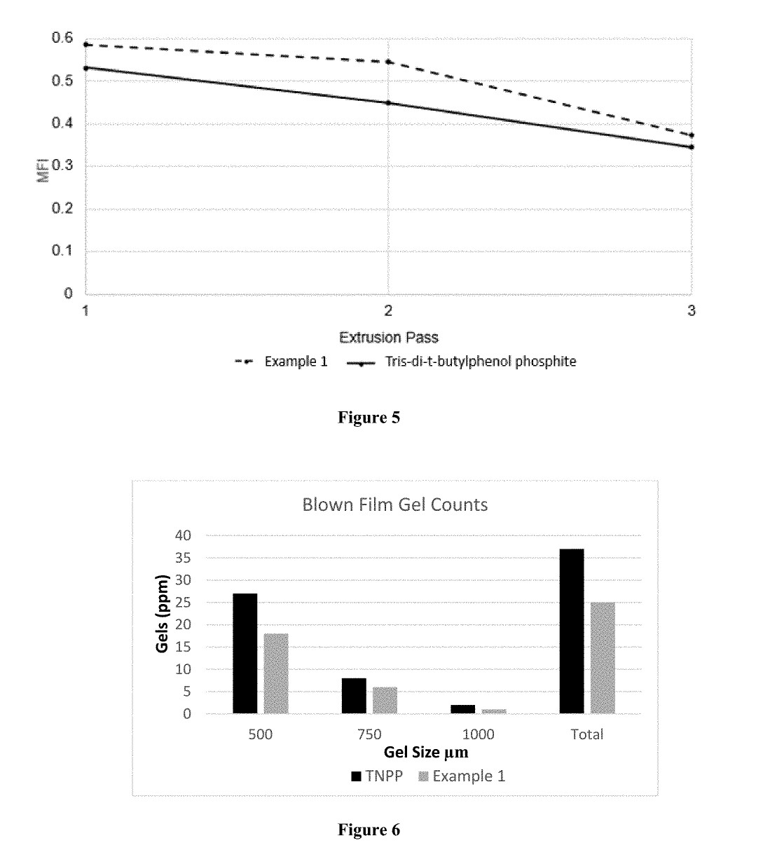

As shown in FIG. 5, the performance of Example 1 was also evaluated against Tri-di-t-butylphenyl Phosphite. Performance was tested in a 0.5 MI LLDPE resin. MI was measured after 1^{st}, 2^{nd}, and 3^{rd} passes.

### Example 7

### Blown Film

Film production is one of the largest and most important applications for polyolefins. Stabilizers are included, in part, to reduce the formation of small gels in the polymer film.

A blown film trial was run to compare the performance of the phosphite prepared in example 1 to the performance of the standard phosphite TNPP. Both phosphites were loaded into the polymer at 1800 ppm. The blown film was produced according to the conditions below.

### Blown Film Conditions

Die Gap: 50 mil
Blow up ratio: 2:5:1
Film thickness: 1-1.5 mil
Output: 250 lbs/hr

The blown film was then analyzed using an online gel camera to determine the number of gels present. Gels were classified by sizes. The film stabilized with the phosphite of example 1 showed superior performance in preventing gels of all sizes. As shown in FIG. 6, the total amount of gels was reduced by approximately 30% compared to TNPP, thereby providing a film of superior quality.

What is claimed is:

1. A composition comprising:
a film having linear low density polyethylene and a first antioxidant component that is: 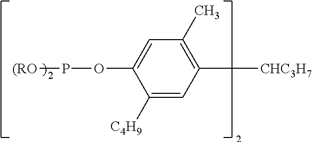
wherein each R moiety is independently selected and is a C8-C20 alkyl moiety.

2. The composition of claim 1, wherein each R moiety is independently selected and is a C13 alkyl moiety.

3. The composition of claim 1, wherein each R moiety is independently selected and is a branched C13 alkyl moiety.

4. The composition of claim 1, wherein the first antioxidant component is present in the film in an amount ranging from 0.001 weight percent to about 5 weight percent.

5. The composition of claim 1, wherein the first antioxidant component is present in the film in an amount ranging from 0.01 weight percent to 2.0 weight percent.

6. The composition of claim 1, wherein the first antioxidant component is present in the film in an amount ranging from 0.025 weight percent to 1 weight percent.

7. The composition of claim 1, wherein the film has a thickness ranging from 0.05 mils to 5 mils.

8. The composition of claim 1, wherein the film has a thickness ranging from 0.05 mils to 20 mils.

9. The composition of claim 1, further comprising a second antioxidant component that is:
i) octadecyl-3-(3.5-ditert butyl-4-hydroxyphenyl)-propionate;
ii) pentaerythriol tetrakis (3-(3.5-ditert butyl-4-hydroxyphenyl)-propionate); or
iii) a combination thereof.

10. The composition of claim 9, wherein the second antioxidant component is octadecyl-3-(3.5-ditert butyl-4-hydroxyphenyl)-propionate.

11. The composition of claim 9, wherein the second antioxidant component is pentaerythriol tetrakis (3-(3.5-ditert butyl-4-hydroxyphenyl)-propionate).

12. The composition of claim 1, further comprising an additional component that is:
i) triethanolamine;
ii) triisopropanolamine; or
iii) a combination thereof.

13. The composition of claim 12, wherein the additional component is triethanolamine.

14. The composition of claim 12, wherein the additional component is triisopropanolamine.

15. The composition of claim 1, wherein the film is a blown film that has at least 30% fewer gels per unit area compared to a control film that was manufactured in the same way and has the same chemical formulation as the film except that the control film chemical formulation replaces the first antioxidant with tris nonylphenol phosphite in the same weight percentage.
